(19) United States
(12) Patent Application Publication
(10) Pub. No.: US 2018/0111716 A1
(43) Pub. Date: Apr. 26, 2018

(54) DOUBLE-SURFACE CONTACT TRAY LOADING BASE

(71) Applicant: CRRC MEISHAN CO., LTD., Meishan City, Sichuan (CN)

(72) Inventors: JINGANG HAN, Meishan City, Sichuan (CN); PING ZHENG, Meishan City, Sichuan (CN); SHIWEI YANG, Meishan City, Sichuan (CN); YI WANG, Meishan City, Sichuan (CN); AIMIN WANG, Meishan City, Sichuan (CN); DONG LI, Meishan City, Sichuan (CN); JIANCHAO LI, Meishan City, Sichuan (CN); LIAO PENG, Meishan City, Sichuan (CN); PU WANG, Meishan City, Sichuan (CN)

(21) Appl. No.: 15/568,454

(22) PCT Filed: Feb. 4, 2016
(86) PCT No.: PCT/CN2016/073432

§ 371 Date: Oct. 20, 2017

(30) Foreign Application Priority Data
Apr. 23, 2015 (CN) 201510196700.7

(51) Int. Cl. B65D 19/38; A47B 57/42; B65G 1/14

(52) U.S. Cl. CPC B65D 19/385; B65G 1/14; A47B 57/42

(57) ABSTRACT

A double-surface contact tray loading base comprises a loading surface (4) and a hook (1) arranged on an outer end of the loading surface (4), the hook (1) comprises a hook lug (1-2) and a support plate (6), the hook lug (1-2) is arranged on an upper side of the outer end of the loading surface (4), and the support plate (6) is arranged on a lower side of the outer end of the loading surface (4), thus forming the double-surface contact tray loading base.

### TECHNICAL FIELD

A double-surface contact tray loading base relates to a cargo transport device, in particular to a tray for container transportation, belonging to the technical field of cargo transport.

### BACKGROUND ART

At present, during the container transportation of cargo, trays are widely used in a compartment for the purpose of sorting and layering cargo, however, in terms of tray support, a simple method is adopted, which is implemented by hanging the hooks and loading surfaces on brackets which are mounted on the side walls of the compartment, so as to support the trays. In this structure, the state of stress on the hooks is bad, the strength and fatigue life of the hooks are lower, the problem of stress concentration occurs frequently. When in use, the device is prone to cracks, even tears, resulting in a severe impact on the safety of cargo transport.

### SUMMARY OF THE INVENTION

The present invention aims to solve the problems mentioned above, and provides a tray support device having reasonable stress state and improved loading capability and service life. The technical solution is as follows:

The device comprises a loading surface and a hook arranged on an outer end of the loading surface, and is characterized in that the hook comprises a hook lug and a support plate, the hook lug is arranged on an upper side of the outer end of the loading surface, the support plate is arranged on a lower side of the outer end of the loading surface, thus forming the double-surface contact tray loading base.

The lower end of the hook lug has a mounting surface at the lower end connected to the upper side of the outer end of the loading surface, and the upper end of the hook lug has an inner contact surface.

The lower end of the support plate has an outer contact surface.

A longitudinal stopper and a transversal stopper are arranged at the adjacent edges of the loading surface, respectively.

A reinforcement rib is arranged at the bottom of the loading surface. The outer end of the loading surface is tilted upwards with an angle of 3-50 degrees. The longitudinal stopper is tilted towards the direction of the hook with an angle of 2-30 degrees.

Compared with the prior art, the present invention has the following benefits:

1. The hook lug and the support plate are respectively arranged on the upper and lower sides of the outer end of the loading surface, thus forming the double-surface contact tray loading base. In a working position, the base is mounted in a seat form on a bracket which is mounted on the side wall of a compartment, with the mounting surface of the hook lug being pressed on a square hole of the bracket, the inner contact surface of the hook lug being in contact with the inner surface on the upper side of the bracket, the outer contact surface of the support plate being in contact with the outer surface on the lower side of the bracket, thus changing the single-sided stress state in the prior art. With the double-sided contact stress between the hook lug and support plate and the bracket, the stress area is increased, the stress delivered to the bracket is dispersed, and the stress delivered to the side wall and the bracket is reduced, as a result, the problem of stress concentration in the existing structures is avoided, the stability of the base is improved, the loading capacity of the base is increased by 80%, the service life is increased by about 68%, thus ensuring the safety of cargo transport.

2. The hook lug and the support plate limit the transversal movement of the base to prevent the base from falling from the bracket, thus ensuring the stability of the base.

3. The longitudinal stopper and the transversal stopper are arranged at the adjacent edges of the loading surface respectively, so as to limit the transversal and longitudinal movement of the base, thus ensuring the stability of the base during the cargo transport process.

4. Taking the horizontal plane as reference, the outer end of the loading surface is tilted upwards with an angle of 3-50 degrees, and when a load is applied to the loading surface of the base, the base deforms, thus ensuring the loading surface in the horizontal position.

5. The longitudinal stopper is tilted towards the direction of the hook with an angle of 2-30 degrees, so as to take the guide effect when the base is mounted.

6. The use of the reinforcement rib improves the strength of the base, increases the vertical loading capability of the base, and increases the fatigue life and service life.

### BRIEF DESCRIPTION OF THE DRAWINGS

FIG. 1 schematically shows a structure of a base of the present invention;

FIG. 2 is a front view of a base of the present invention;

FIG. 3 is a using state of the present invention;

FIG. 4 is partially enlarged sectional view of a using state of the present invention;

### DETAILED DESCRIPTION OF THE INVENTION

### The Embodiment 1

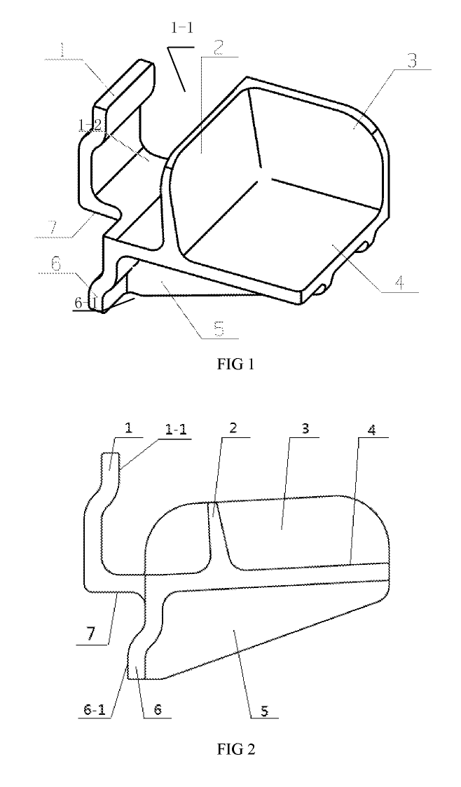

Referring to FIG. 1 and FIG. 2, the present embodiment comprises a loading surface 4 and a hook 1 arranged on the outer end of the loading surface 4, and is characterized in that the hook 1 comprises a hook lug 1-2 and a support plate 6, the hook lug 1-2 is arranged on an upper side of the outer end of the loading surface, the support plate 6 is arranged on a lower side of the outer end of the loading surface, thus forming the double-surface contact tray loading base. The hook lug 1-2 has a mounting surface 7 at the lower end, which is connected to an upper side of the outer end of the loading surface, and the hook lug has an inner contact surface 1-1 at the upper end. The support plate 6 has an outer contact surface 6-1 at the lower end.

### The Embodiment 2

The present embodiment comprises a loading surface 4 and a hook 1 arranged on an outer end of the loading surface 4, and is characterized in that the hook 1 comprises a hook lug 1-2 and a support plate 6, the hook lug 1-2 is arranged on an upper side of the outer end of the loading surface, the support plate 6 is arranged on a lower side of the outer end of the loading surface, thus forming the double-surface contact tray loading base. The hook lug 1-2 has a mounting surface 7 at the lower end, which is connected to the upper side of the outer end of the loading surface, and the hook lug has an inner contact surface 1-1 at the upper end. The support plate 6 has an outer contact surface 6-1 at the lower end. A longitudinal stopper 2 and a transversal stopper 3 are arranged at the adjacent edges of the loading surface 4, respectively.

### The Embodiment 3

The present embodiment comprises a loading surface 4 and a hook 1 arranged on an outer end of the loading surface 4, and is characterized in that the hook 1 comprises a hook lug 1-2 and a support plate 6, the hook lug 1-2 is arranged on an upper side of the outer end of the loading surface, the support plate 6 is arranged on a lower side of the outer end of the loading surface, thus forming the double-surface contact tray loading base. The hook lug 1-2 has a mounting surface 7 at the lower end, which is connected to the upper side of the outer end of the loading surface, and the hook lug has an inner contact surface 1-1 at the upper end. The support plate 6 has an outer contact surface 6-1 at the lower end. A longitudinal stopper 2 and a transversal stopper 3 are arranged at the adjacent edges of the loading surface 4, respectively. A reinforcement rib 5 is arranged at the bottom of the loading surface 4.

### The Embodiment 4

The present embodiment comprises a loading surface 4 and a hook 1 arranged on an outer end of the loading surface 4, and is characterized in that the hook 1 comprises a hook lug 1-2 and a support plate 6, the hook lug 1-2 is arranged on an upper side of the outer end of the loading surface, the support plate 6 is arranged on a lower side of the outer end of the loading surface, thus forming the double-surface contact tray loading base. The hook lug 1-2 has a mounting surface 7 at the lower end, which is connected to the upper side of the outer end of the loading surface, and the hook lug has an inner contact surface 1-1 at the upper end. The support plate 6 has an outer contact surface 6-1 at the lower end. A longitudinal stopper 2 and a transversal stopper 3 are arranged at the adjacent edges of the loading surface 4, respectively. A reinforcement rib 5 is arranged at the bottom of the loading surface 4. The outer end of the loading surface 4 is tilted upwards with an angle of 3-50 degrees, and the longitudinal stopper 2 is tilted towards the direction of the hook with an angle of 2-30 degrees.

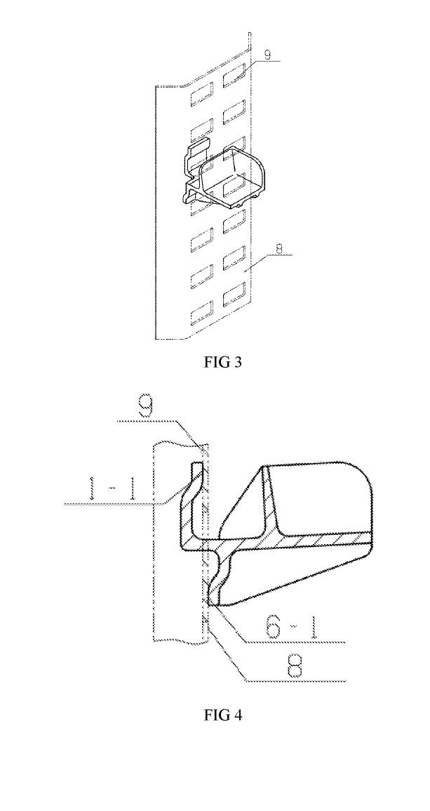

When in use, as shown in FIG. 3 and FIG. 4, the base is mounted in a seat form on a bracket 8 which is mounted on the side wall of a compartment, with the mounting surface 7 of the hook lug being pressed on a square hole 9 of the bracket, the inner contact surface 1-1 of the hook lug being in contact with the inner surface on the upper side of the bracket, the outer contact surface 6-1 of the support plate being in contact with the inner surface on the lower side of the bracket, in this manner, the base is mounted in place and then a tray is mounted on the base.

1. A double-surface contact tray loading base, comprising a loading surface (4) and a hook (1) arranged on an outer end of the loading surface (4), characterized in that the hook (1) comprises a hook lug (1-2) and a support plate (6), the hook lug (1-2) is arranged on an upper side of the outer end of the loading surface, the support plate (6) is arranged on a lower side of the outer end of the loading surface, thus forming the double-surface contact tray loading base.

2. The double-surface contact tray loading base according to claim 1, characterized in that the lower end of the hook lug (1-2) has a mounting surface (7) connected to the upper side of the outer end of the loading surface, and the upper end of the hook lug has an inner contact surface (1-1).

3. The double-surface contact tray loading base according to claim 1, characterized in that the lower end of the support plate (6) has an outer contact surface (6-1).

4. The double-surface contact tray loading base according to claim 1, characterized in that a longitudinal stopper (2) and a transversal stopper (3) are arranged at the adjacent edges of the loading surface (4), respectively.

5. The double-surface contact tray loading base according to claim 1, characterized in that a reinforcement rib (5) is arranged at the bottom of the loading surface (4).

6. The double-surface contact tray loading base according to claim 1, characterized in that the outer end of the loading surface (4) is tilted upwards with an angle of 3-50 degrees.

7. The double-surface contact tray loading base according to claim 1, characterized in that the longitudinal stopper (2) is tilted towards the direction of the hook with an angle of 2-30 degrees.
